(19) United States
(12) Patent Application Publication
(10) Pub. No.: US 2026/0147414 A1
(43) Pub. Date: May 28, 2026

(54) HAPTIC FEEDBACK ACTUATORS FOR PROVIDING INFORMATION VIA WEARABLE DEVICES, SYSTEMS, AND METHODS OF USE THEREOF

(71) Applicant: Meta Platforms Technologies, LLC, Menlo Park, CA (US)

(72) Inventors: Pornthep Preechayasomboon, Redmond, WA (US); Henry Alexander Duhaime, Seattle, WA (US); Andre Levi, Seattle, WA (US); Sarah Sykes, Kirkland, WA (US); James Tichenor, Seattle, WA (US)

(21) Appl. No.: 19/402,901

(22) Filed: Nov. 26, 2025

Related U.S. Application Data
(60) Provisional application No. 63/726,131, filed on Nov. 27, 2024.

(51) Int. Cl. G06F 3/01

(52) U.S. Cl. CPC G06F 3/016; G06F 3/014

(57) ABSTRACT

A method of providing information to a user regarding an extended reality event with a wearable device is disclosed. The method includes determining that the extended reality event has occurred in an extended reality application. The method also includes determining an event type and an urgency level of the extended reality event. The method also includes causing a wearable device to provide one or more haptic feedback signals to the user based on the event type and the urgency level of the extended reality event.

### RELATED APPLICATION

This application claims priority to U.S. Provisional Application Ser. No. 63/726,131, filed Nov. 27, 2024, entitled “Apparatus, System, and Method for Conveying Information to Users of Artificial-Reality Systems via Combinational Haptic Feedback,” which is incorporated herein by reference.

### TECHNICAL FIELD

This relates generally to systems including wearable devices for providing information to users regarding an extended-reality event. Particularly, the system relates to vibration and pressure actuators that provide haptic feedback signals via a wearable device to a user regarding extended reality events occurring in an extended reality application.

### BACKGROUND

Users of artificial-reality or extended reality systems may interact with physical objects, extended reality objects, extended reality input devices or instruct the system to perform certain functions. Further, these systems may receive commands from the user or analyze user actions (e.g., through cameras or other wearable devices). Users, engaging with artificial-reality or extended reality systems, might lack indications from the system that it received their command or registered certain user actions. Users are confined to receiving visual or auditory information and/or notifications.

As such, there is a need to address one or more of the above-identified challenges. A brief summary of solutions to the issues noted above are described below.

### SUMMARY

One example of a computing system is described herein. The example computing system includes a wearable device that is communicatively coupled with a computing device. The wearable device comprises a number of actuators, for example, vibration and pressure actuators. The computing device is configured to determine that an extended reality event has occurred in an extended reality application. The computing device is configured to determine an event type and an urgency level of the extended reality event. The computing device is configured to cause the wearable device to provide one or more haptic feedback signals to a user based on the event type and the urgency level of the extended reality event.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate a wearable-device configured to provide vibration and/or pressure haptic feedback signals to provide information to a user based on extended reality events in accordance with some embodiments.

FIGS. 2A-2D illustrate a user wearing an extended reality headset operatively coupled to a wearable device configured to provide vibration and/or pressure haptic feedback signals to the user based on user interactions with real objects.

FIGS. 3A-3D illustrate a point of view of a user wearing an extended reality headset operatively coupled to a wearable device configured to provide vibration and/or pressure haptic feedback signals to the user based on user interactions with a real object.

FIGS. 4A and 4B illustrate a user wearing an extended reality headset operatively coupled to a wearable device configured to provide vibration and/or pressure haptic feedback signals to the user based on user interactions with an extended reality object.

FIGS. 5A-5D illustrate a point of view of a user wearing an extended reality headset operatively coupled to a wearable device engaging in extended reality functions.

FIGS. 6A-6C illustrate an example of a user commanding a computing device communicatively coupled to a wearable device to start, perform, and stop a function in accordance with some embodiments

FIGS. 7A-7D illustrate a user wearing an extended reality headset operatively coupled to a wearable device configured to provide vibration and/or pressure haptic feedback signals based corresponding to a suggested user action.

FIGS. 8A-8C illustrate a user wearing an extended reality headset operatively coupled to a wearable device configured to provide vibration and/or pressure haptic feedback signals to the user based on known information.

FIG. 9 illustrates an example method of providing a haptic feedback signal to provide information to a user in accordance with some embodiments.

FIGS. 10A, 10B, 10C-1, and 10C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Wearable Device With Vibration And/or Pressure Actuators for Providing Haptic Feedback Signals

Certain wearable devices can include vibration and/or pressure actuators (hereinafter, referred to collectively as “actuators”) to provide haptic feedback to a user to provide information to the user. The information provided to the user may, for example, may include one or more of a notification, start of a function, end of a function, acknowledgement of a user input, and/or a suggestion regarding a user action with respect to a physical (i.e., a real-world) or virtual object. When the actuator is activated, the user may receive a vibration and/or pressure from the wearable device.

As described herein, embodiments of the wearable devices including actuators can provide haptic feedback to a user. Advantageously, by including the actuators, a computing device can provide indications to a user wearing an augmented reality or extended reality headset that the user, otherwise, would only be able to receive via auditory or visual means. Such auditory or visual notifications can disrupt the augmented reality or extended reality experience or application that the user is engaging. Further, current systems that provide haptic feedback signals to users generally involve controllers rather than wearables. The use of controllers rather than a wearable renders the user incapable of engaging with extended reality, augmented-reality, or real-world objects. Thus, the use of a wearable device to provide haptic feedback signals to a user allows the user to engage with extended reality, augmented-reality, or real-world objects while also receiving non-disruptive indications or notifications from the system.

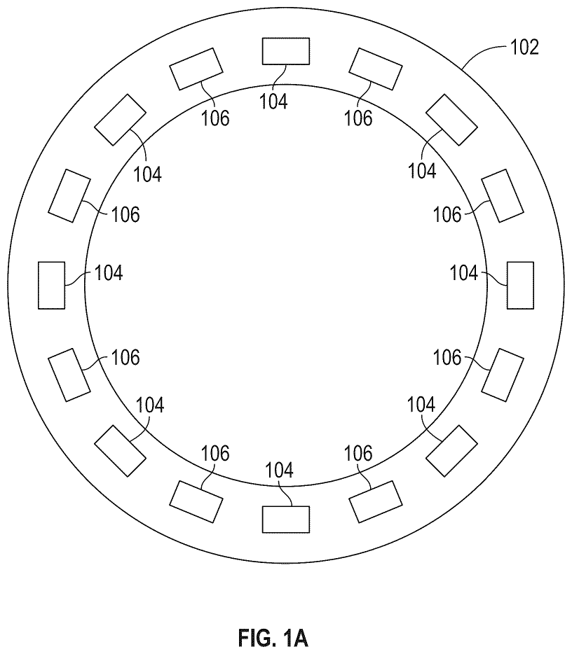

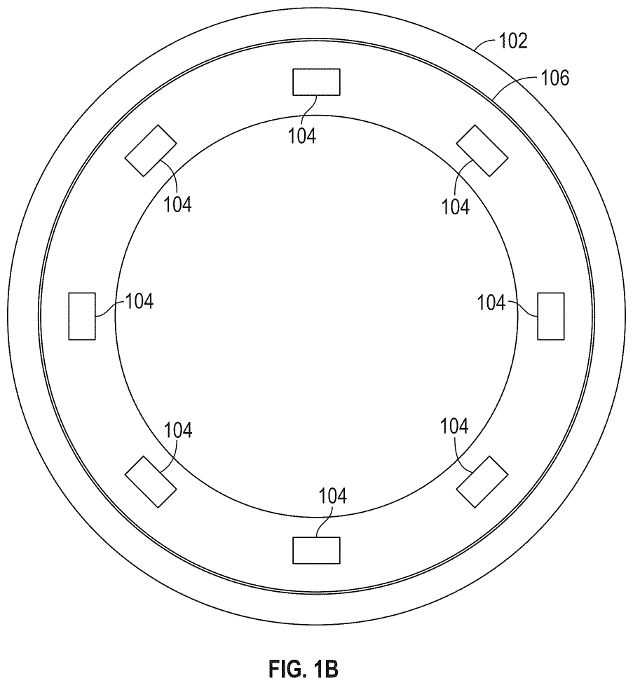

FIGS. 1A-B illustrate example wearable devices in accordance with some embodiments. FIG. 1A illustrates a side view cross-section of an example wearable device 102 in accordance with some embodiments. The wearable device 102 is intended to be worn around a user's wrist region, however, in some embodiments, the wearable device could be worn around any region where the user could receive haptic feedback signals from the wearable device. In some embodiments, the wearable device 102 may be integrated into other devices such as a headset. In some embodiments, the wearable device 102 may also include other functions in addition to providing haptic feedback signals to a user such as sensing user actions or receiving commands from a user. The wearable device 102 may include one or more vibration actuators 104 and/or pressure actuators 106. In some embodiments, the wearable device may include both vibration actuators 104 and pressure actuators 106. In other embodiments, the wearable device may include only one of vibration actuators 104 and pressure actuators 106. In some embodiments, the actuators can provide varying levels of signal to the user (e.g., vibrations or pressures of differing intensities and/or characteristics). In some embodiments, the wearable device 102 may be communicatively coupled to a computing system or a headset. In some embodiments, the computing system or headset may cause the wearable device to provide one or more haptic feedback signals to the user.

FIG. 1B illustrates a side view cross-section of an example wearable device 102 in accordance with some embodiments. The wearable device 102 includes one or more vibration actuators 104 and a single pressure actuator 106 that encompasses the wearable device 102. It will be understood that different actuator configurations may be implemented.

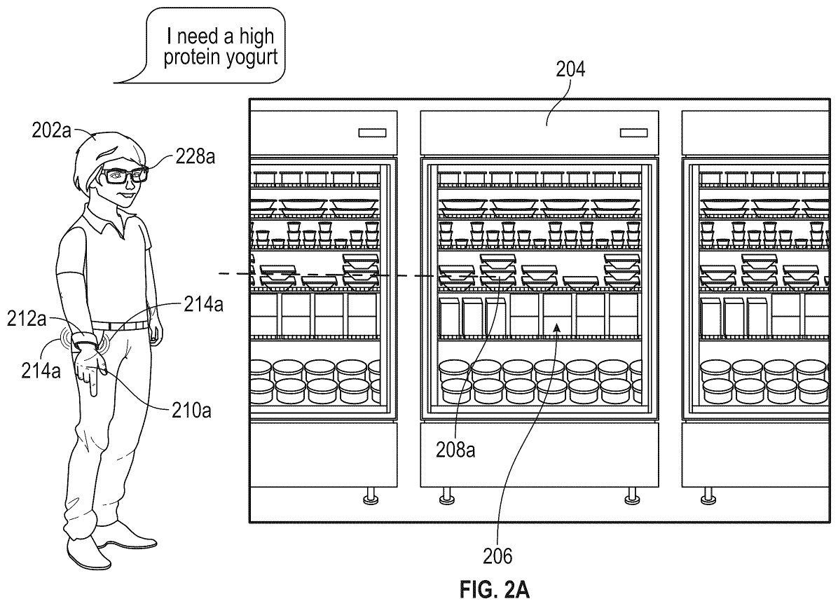

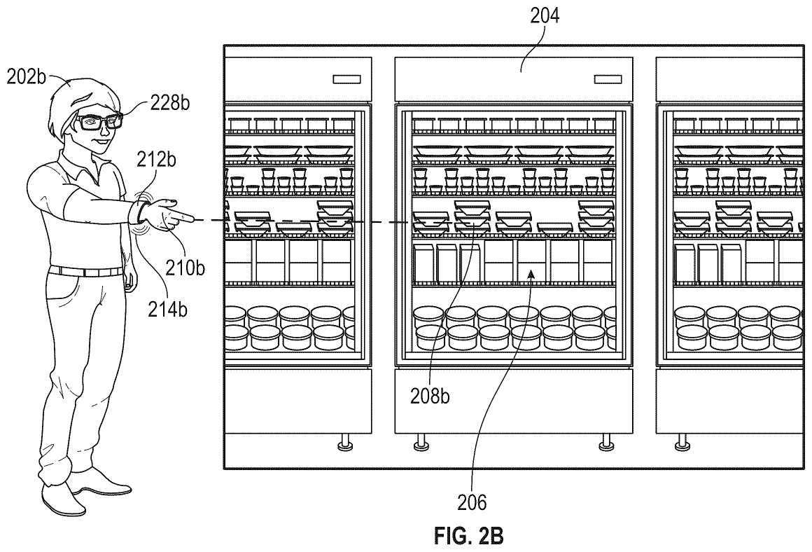

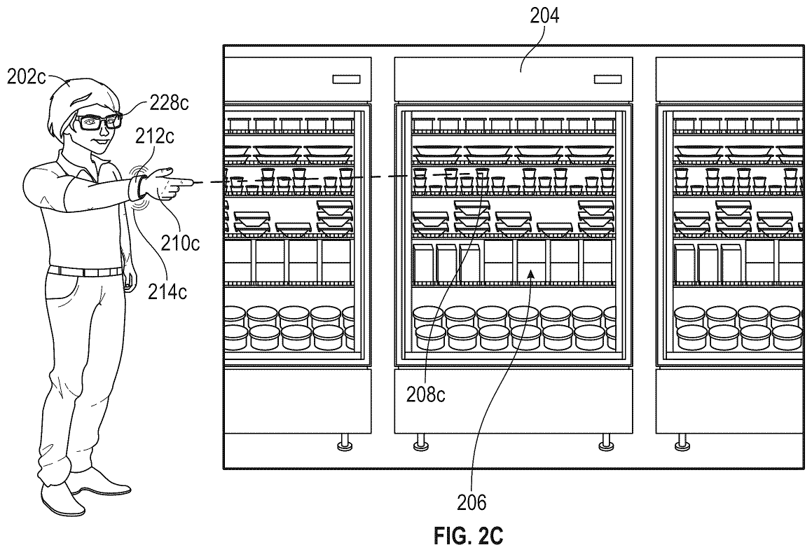

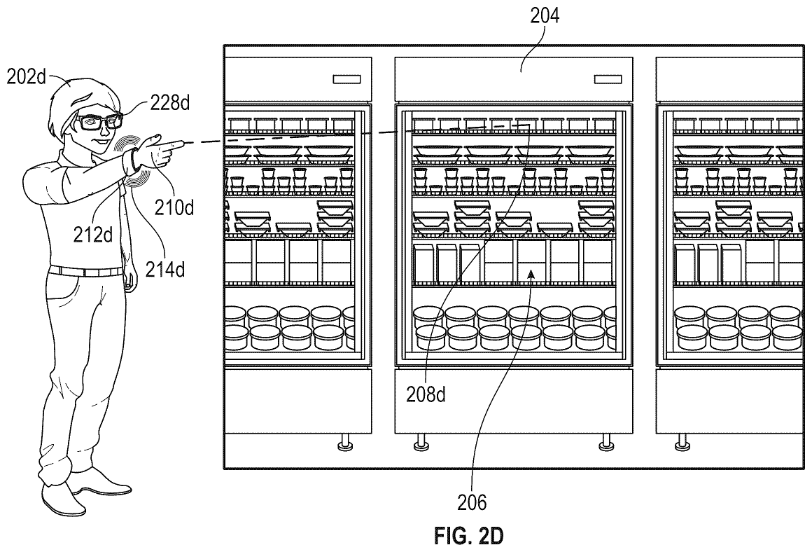

FIGS. 2A-D illustrate an example extended reality event. In the extended reality event, a user 202a-d is wearing an extended reality headset 228a-d and wearable device 212a-d in accordance with some embodiments. The extended reality headset 228a-d may be communicatively coupled to a computing device. The extended reality event may include one or more sub-events. FIG. 2A illustrates an example first sub-event. In the first sub-event, the computing device started a function, and the computing device causes the wearable device 212a to provide a first haptic feedback signal to the user 202a indicating the first sub-event occurred. In some embodiments, the first sub-event may be triggered, for example, because of one or more of a user action, an environmental response in the extended reality event, or a state change of the computing device. In FIG. 2A, the user stated that “[he] need[s] a high protein yogurt”, triggering the first sub-event. In some embodiments, the extended reality event may include a second sub-event. In some embodiments, the statement may be made in close succession to subsequent sub-events. In other embodiments, the statement may be made at a temporally removed period from subsequent sub-events. In some embodiments, the wearable device may provide a first vibration haptic feedback signal 214a indicating that it started a function (e.g., acknowledging that the user needs high protein yogurts). In some embodiments, the first haptic feedback signal may be a pressure haptic feedback signal or multiple haptic feedback signals. In some embodiments, the wearable device 212a may not provide a haptic feedback signal to the user 202a to indicate that it started a function.

FIG. 2B illustrates an example second sub-event of the extended reality event. In the second sub-event the computing device causes the wearable device to provide one or more second haptic feedback signal to the user based on the one or more user actions. For example, in FIG. 2B, user 202b observes the fridge 204b containing a selection of yogurt 206b. The user may indicate a selection of a 208b, for example, by pointing at the yogurt selection 208b with his pointer finger 210b. The computing system may determine, based on the first sub-event, that the user 202 needs a high protein yogurt and may analyze the yogurt selection 208b. In some embodiments, the analysis may be further based on inputs from extended reality headset 228 or other devices. The computing device may determine that the yogurt selection 208b does not meet the criteria of being high protein and may cause the wearable device 212b to provide a second vibration haptic feedback signal 214b to the user 202, indicating that the yogurt selection 208b is not high protein. The second vibration haptic feedback signal 214b may be one of a variety of different feedback signals such as a pulsing, momentary, or long vibration, such that the user 202 understands that the yogurt selection 208b does not meet the criteria set forth in the first sub-event. In some embodiments, the second haptic feedback signal may be a pressure haptic feedback signal or multiple haptic feedback signals.

FIG. 2C continues to illustrate the second sub-event of the extended reality event. In FIG. 2C, user 202 observes the fridge 204 containing a selection of yogurt 206. The user points to a different yogurt 208c with his pointer finger 210c. The computing system may determine, based on the first sub-event, that the user 202 needs a high protein yogurt and may analyze the yogurt selection 208c. In some embodiments, the analysis may be further based on inputs from extended reality headset 228 or other devices. The computing device may determine that the yogurt selection 208c does not meet the criteria of being high protein and may cause the wearable device 212c to provide a third vibration haptic feedback signal 214c to the user 202c, indicating that the yogurt selection 208c is not high protein. The third vibration haptic feedback signal 214c may be one of a variety of different feedback signals such as a pulsing, momentary, or long vibration, such that the user 202 understands that the yogurt selection 208c does not meet the criteria set forth in the first sub-event. In some embodiments, the third haptic feedback signal may be a pressure haptic feedback signal or multiple haptic feedback signals.

FIG. 2D illustrates a third sub-event of the extended reality event. wherein the third sub-event is that the computing device completed the function started in the first sub-event, and the computing device causes the wearable device to provide a fourth haptic feedback signal to the user indicating the third sub-event occurred. In FIG. 2D, user 202d observes the fridge 204d containing a selection of yogurt 206d. The user points to a yogurt 208d with his pointer finger 210d. The computing system may determine, based on the first sub-event, that the user 202 needs a high protein yogurt and may analyze the yogurt selection 208d. In some embodiments, the analysis may be further based on inputs from extended reality headset 228d or other devices. The computing device may determine that the yogurt selection 208d meets the criteria of being high protein and may cause the wearable device 212d to provide a fourth vibration haptic feedback signal 214d to the user 202d, indicating that the yogurt selection 208d is high protein. The fourth vibration haptic feedback signal 214d may be one of a variety of different feedback signals such as a pulsing, momentary, or long vibration, such that the user 202d understands that the yogurt selection 208d meets the criteria set forth in the first sub-event. In some embodiments, the fourth vibration haptic feedback signal 214d may be a pressure haptic feedback signal or multiple haptic feedback signals. In some embodiments, the fourth vibration haptic feedback signal 214d may be of a greater intensity than first and second vibration haptic feedback signals 214a and 214b (as can be seen in the larger lines of the fourth vibration haptic feedback signal 214d).

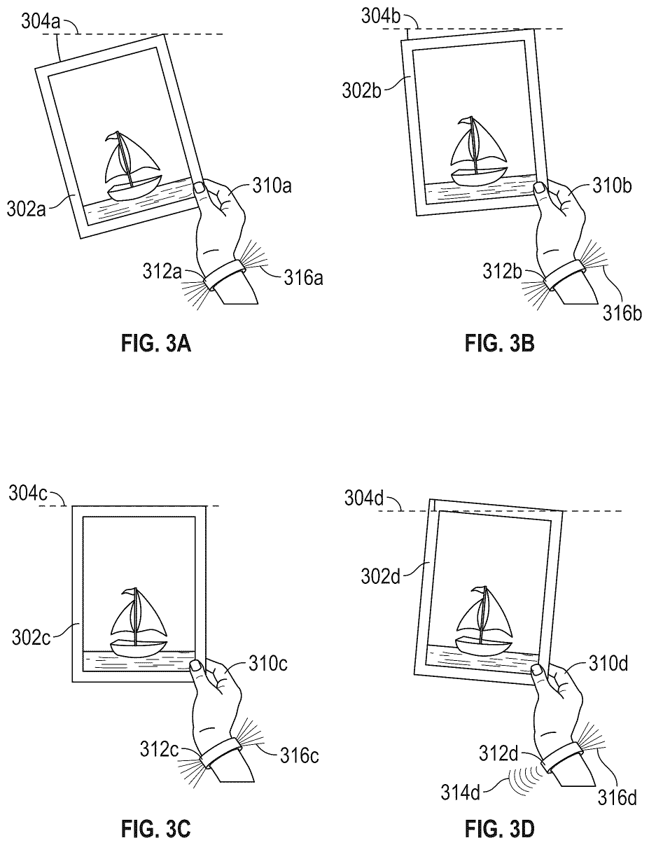

FIGS. 3A-D illustrate an example extended reality event from the point of view of a user interacting with a physical object in accordance with some embodiments. FIGS. 3A-D illustrate an example of providing haptic feedback signals to a user to suggest a user action. In FIG. 3A, the user, wearing wearable device 312a, holds with their hand 310a the portrait 302a and intends to make it level with the horizon 304a. A computing device may cause wearable device 312a to provide a first pressure haptic feedback signal 316a to the user, to indicate that the computing device is starting a function (e.g., providing a suggestion of how to move portrait 302a level to the user).

In FIG. 3B, the user, holding portrait 302b with their hand 310b, moves the portrait 302b closer to the horizon 304b. In some embodiments, wearable device 312b may continue to provide a pressure haptic feedback signal 316b to the user. In other embodiments, wearable device 312b may not provide a pressure haptic feedback signal 316b to the user. In some embodiments, pressure haptic feedback signal 316b may be of a greater intensity than pressure haptic feedback signal 316a (for example, the intensity of pressure haptic feedback signal 316b may indicate to the user that the computing device acknowledges that the user is moving portrait 302b closer to the horizon 304b).

In FIG. 3C, the user, holding portrait 302c with their hand 310c, moves the portrait 302c to the horizon 304c. In some embodiments, wearable device 312c may continue to provide a pressure haptic feedback signal 316c to the user. In other embodiments, wearable device 312c may discontinue providing a pressure haptic feedback signal 316c (for example, to indicate that the user has successfully moved the portrait 302c to the desired location). In some embodiments, pressure haptic feedback signal 316c may be of a greater intensity than pressure haptic feedback signal 316a or 316b (for example, the intensity of pressure haptic feedback signal 316c may indicate to the user that the computing device acknowledges that the user has successfully moved portrait 302c to the horizon 304c).

In FIG. 3D, the user, holding portrait 302d with their hand 310d, moves the portrait 302d past the horizon 304d. In some embodiments, wearable device 312c may continue to provide a pressure haptic feedback signal 316d to the user. In other embodiments, wearable device 312c may discontinue providing a pressure haptic feedback signal 316d (for example, because the user successfully moved the portrait 302c to the desired location, horizon 304c). In some embodiments, pressure haptic feedback signal 316d may be of a greater intensity than pressure haptic feedback signals 316a-c (for example, the intensity of pressure haptic feedback signal 316d may indicate to the user that the portrait 302d was moved past the horizon 304d). In some embodiments, wearable device 312d may provide a vibration haptic feedback signal 314d to the user to indicate that the user moved the portrait 302d past the desired location or horizon 304d. It will be understood that the wearable device 312a-d may provide any combination of pressure haptic feedback signals and/or vibration haptic feedback signals to the user to indicate that the user moved the portrait 302a-c to the desired location 304a-c or that user moved the portrait 302d past the desired location or horizon 304d (e.g., that vibration haptic feedback signal 314d and pressure haptic feedback signal 316d may be provided to the user simultaneously). In some embodiments, the wearable device may provide a more intense haptic feedback signal to the user if the user action requires an urgent suggestion from the computing device.

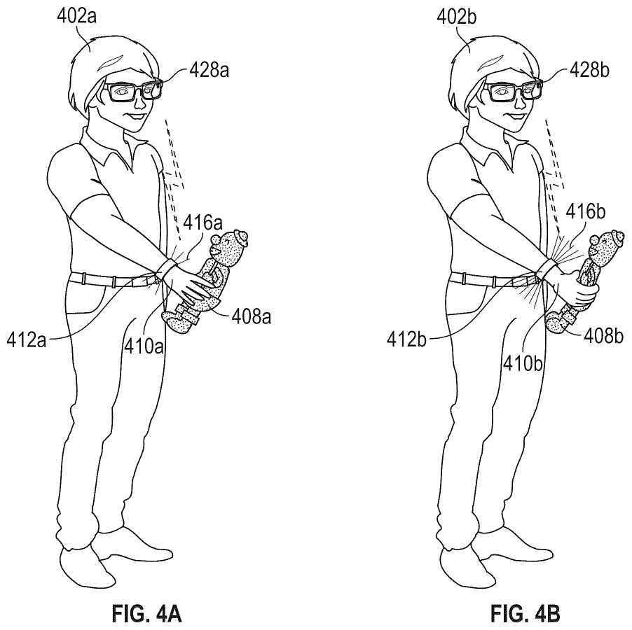

FIGS. 4A and B illustrate an example extended reality event of a user action with an extended reality object and a wearable device providing a haptic feedback signal based on the user action in accordance with some embodiments. In FIG. 4A, user 402a, wearing wearable device 412a and extended reality headset 428a, holds virtual object 408a in his hand 410a. Wearable device 412a may provide a haptic feedback signal (for example, pressure haptic feedback signal 416a) to user 402a, indicating to the user that they have successfully grasped virtual object 408a.

In FIG. 4B, user 402b, wearing wearable device 412b and extended reality headset 428b, holds virtual object 408b in his hand 410b. User 402b squeezes and deforms virtual object 408b. Wearable device 412b may provide a haptic feedback signal (for example, pressure haptic feedback signal 416b) to user 402b. In some embodiments, pressure haptic feedback signal 416b may be of a greater intensity than pressure haptic feedback signal 416a, indicating to user 402b that they are squeezing extended reality object 408b to a greater extended than user 402a was grasping extended reality object 408a. In some embodiments, pressure haptic feedback signal 416a-b may be one or more vibration haptic feedback signals. For example, a vibration actuator may provide pulsing vibrations at different frequencies to user 402a-b to indicate information (e.g., pulses at a lower frequency may indicate the computing device acknowledged less squeezing from the user and pulses at higher frequencies may indicate that the computing device acknowledged more squeezing from the user). It will be understood that the wearable device 412a-b may provide any combination of pressure haptic feedback signals and/or vibration haptic feedback signals to the user to indicate characteristics about the user's interactions with the extended reality object 408a-b.

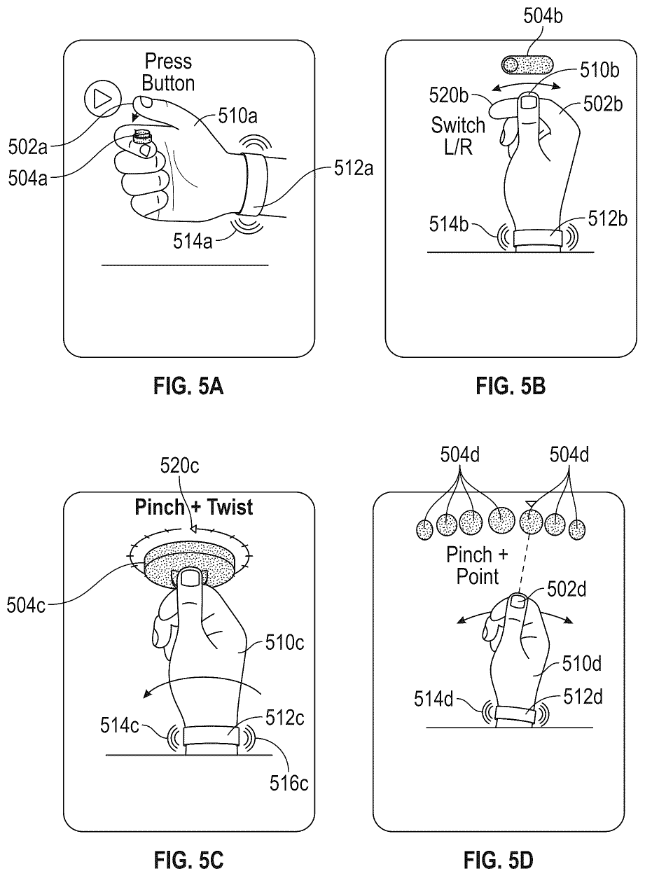

FIGS. 5A-D illustrate examples of a point of view of a user providing commands to an extended reality or virtual input device to command a computing system operatively coupled to wearable device 512a-d in accordance with some embodiments. FIGS. 5A-D illustrate wearable device 512a-d providing a user with any combination of haptic feedback signals (including pressure and vibration) to indicate that a computing device operatively coupled to wearable device 512a-d acknowledged the user's command(s) or action(s). A computing device may cause wearable device 512a-d to provide information to the user indicating that the computing device acknowledged the user's command(s) or action(s). In some embodiments, the extended reality or virtual input device may affect one or more physical objects such as, for example, lights and curtain functions.

FIG. 5A illustrates a point of view of a user wearing wearable device 512a and providing a command to a computing system operatively coupled to wearable device 512a. The user may confirm a selection by pinching one or more fingers in hand 510a. For example, the user may press a virtual button by contacting their pointer finger 502a with their thumb 504a. For example, wearable device 512a may provide pressure haptic feedback signal 514a to indicate to the user that the computing device coupled to wearable device 512a acknowledge the user's command or action.

FIG. 5B illustrates a point of view of a user wearing wearable device 512b and providing a command to toggle an extended reality switch to a computing system operatively coupled to wearable device 512b. The user may toggle virtual switch 504b by, for example, moving thumb 510 b between 502b and 520b. In some embodiments, the wearable device 512b may provide a vibration haptic feedback signal 514b to the user to indicate that it acknowledged the switch toggle.

FIG. 5C illustrates a point of view of a user wearing wearable device 512c and providing a command to an extended reality input device to command a computing system operatively coupled to wearable device 512c. For example, dial 504c may be an extended reality input device. The user may grasp extended reality dial 504c with their hand 510c. The wearable device 512c may provide one or more haptic feedback signals (e.g., a pressure haptic feedback signal 516c) to the user to indicate that the user has successfully pinched or grabbed extended reality dial 504c. The user may provide inputs to the computing system by, for example, rotating extended reality dial 504c in a counter-clockwise direction 520c. The computing device may cause wearable device 512c to provide one or more haptic feedback signals (e.g., vibration haptic feedback signal 514c) to the user to indicate that the computing system acknowledged the user rotating extended reality dial 504c in direction 520c. For example, wearable device 512c may provide a vibration haptic feedback signal 514c as extended reality dial 504c is rotated, acting as an extended reality detent mechanism.

FIG. 5D illustrates a point of view of a user wearing wearable device 512d and providing a command to navigate an extended reality application of a computing system operatively coupled to wearable device 512d. For example, 504d may be an extended reality list of icons such as applications or contacts. The user wearing wearable device 512d may grab one of the icons of list 504d by pinching an icon in hand 510a (e.g., contacting thumb 502d to index finger).

The user may confirm a selection by pinching one or more fingers of hand 510d. For example, the user may press a virtual button by contacting their pointer finger with their thumb 502d. Wearable device 512d may provide one or more haptic feedback signals (e.g., a vibration haptic feedback signal 514d) to the user to indicate that the user has successfully pinched or grabbed an icon from extended reality list 504d. In some embodiments, wearable device 512d provides a sustained haptic feedback signal for so long as the user has selected an icon from extended reality list 504d. In some embodiments, wearable device 514d may provide a momentary haptic feedback signal one or both selection of an icon from extended reality list 504d and release of an icon from extended reality list 504d.

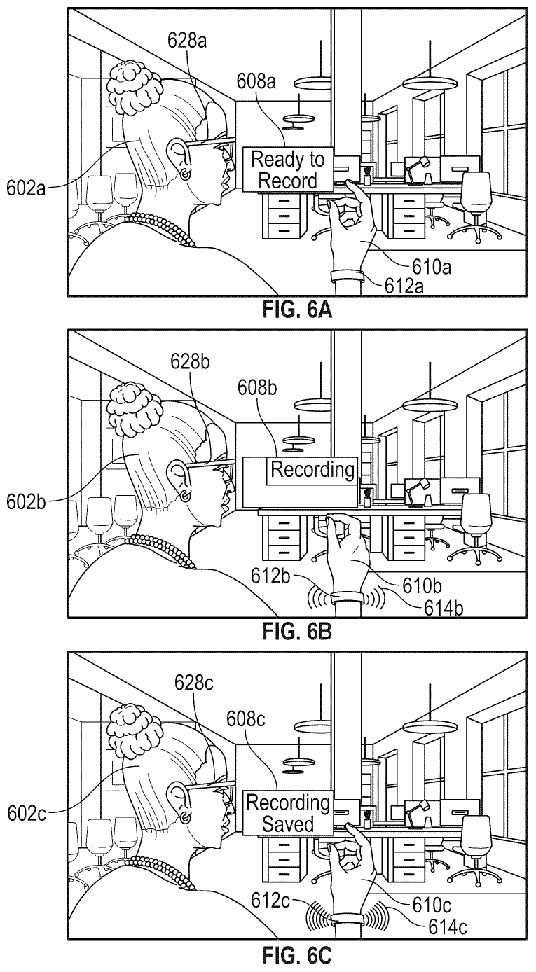

FIGS. 6A-C illustrate an example of a user commanding a computing device communicatively coupled to a wearable device to start, perform, and stop a function in accordance with some embodiments. FIG. 6A illustrates a user preparing to begin a recording. User 602a, wearing extended reality headset 628a and wearable device 612a, is preparing to record a video. User 602a sees a popup indicating that the computing system is ready to record (608a). The recording is configured to begin and continue for so long as the hand 610a of user 602a is in a pinched position.

FIG. 6B illustrates the computing device causing the wearable device 612b providing a haptic feedback signal (e.g., vibration haptic feedback signal 614b) to user 602b while the computing system is recording the video. For example, user 602b, wearing extended reality headset 628b and wearable device 612b, pinches the fingers of their hand 610b, beginning the recording and sees a popup indicating that the computing system is recording (608b). In some embodiments, wearable device 612b may provide a sustained haptic feedback signal (e.g., vibration haptic feedback signal 614b) for so long as the computing device is recording the video (e.g., for so long as the function of the extended reality application is running). In some embodiments, wearable device 612b may provide varying haptic feedback signals depending on the circumstances of the extended reality application. In other embodiments, wearable device 612b may provide a momentary haptic feedback signal to user 602b to indicate that the function started.

FIG. 6C illustrates the computing device causing the wearable device 612c providing a haptic feedback signal (e.g., vibration haptic feedback signal. 614c) to user 602c to indicate that recording has been saved or completed (e.g., that the function of the extended reality application is complete). For example, user 602c, wearing extended reality headset 628c and wearable device 612c, may release the pinched fingers of their hand 610c to command the computing device to end the recording. In some embodiments, wearable device 612c may provide a haptic feedback signal (e.g., vibration haptic feedback signal 614c) different from the vibration haptic feedback signal 612b (e.g., of a different intensity or characteristics) to indicate that the recording has been saved 608c (i.e., that the function of the extended reality application that was running in FIG. 6B is complete). In some embodiments, wearable device 612c may discontinue providing haptic feedback signals to the user to indicate that the recording has been saved 608c.

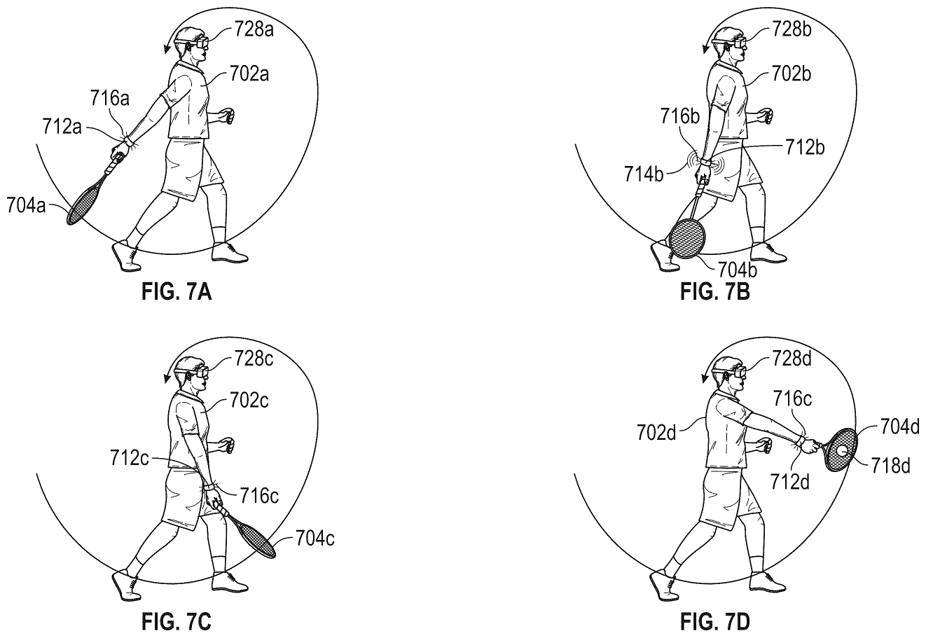

FIGS. 7A-D illustrate an example wearable device providing haptic feedback signals to a user to provide a suggested user action (e.g., providing a suggestion regarding tennis swing). The suggested user action, for example, may be based on a determination, by the computing device, regarding one or more of a position of the user, position of an object the user is interacting with, position of an extended reality object the user is interacting with, force exerted by the user, and limb orientation and dynamics of the user. FIGS. 7A-D illustrate a user being coached on how to swing a tennis racket correctly.

FIG. 7A shows user 702a holding a racket 704a and wearing extended reality headset 728a and wearable device 712a. In some embodiments, wearable device 712a may provide a first haptic feedback signal (e.g., pressure haptic feedback signal 716a) to user 702a to indicate that a computing device has begun a function. For example, wearable device 712a may provide pressure haptic feedback signal 716a to indicate that it is monitoring swing mechanics of user 702a. In some embodiments, wearable device 712a may provide a momentary haptic feedback signal to indicate that the swing-monitoring extended reality application has begun. In other embodiments, wearable device 712a may provide a sustained haptic feedback signal for so long as the function of the extended reality application (e.g., swing-monitoring) is running. In some embodiments, wearable device 712a may not provide a haptic feedback signal.

FIG. 7B shows user 702b holding a racket 704b and wearing extended reality headset 728b and wearable device 712b. In some embodiments, wearable device 712b may continue to provide the first haptic feedback signal (e.g., pressure haptic feedback signal 716b) to user 702b to indicate that the computing device is continuing the function of the extended reality application (e.g., the swing-monitoring). In some embodiments, wearable device 712b may not continue to provide the first haptic feedback signal (e.g., pressure haptic feedback signal 716b) to user 702b to indicate that the computing device is continuing the function of the extended reality application (e.g., the swing-monitoring). In some embodiments, wearable device 712b may provide a second haptic feedback signal (e.g., vibration haptic feedback signal 714b) to user 702b to suggest a user action. For example, in FIG. 7B, the racket 704b is oriented incorrectly, such that the racket face would not contact the ball. In some embodiments, wearable device 712b may provide the second haptic feedback signal (e.g., vibration haptic feedback signal 714b) to user 702b to indicate that racket 704b is not oriented correctly. In some embodiments, the first haptic feedback signal and the second haptic feedback signal may be provided to the user simultaneously.

FIG. 7C shows user 702c holding a racket 704c and wearing extended reality headset 728c and wearable device 712c. In some embodiments, wearable device 712b may continue to provide the first haptic feedback signal (e.g., pressure haptic feedback signal 716c) to user 702c to indicate that the computing device is continuing the function of the extended reality application (e.g., the swing-monitoring). In some embodiments, wearable device 712c may not continue to provide the first haptic feedback signal (e.g., pressure haptic feedback signal 716c) to user 702c to indicate that the computing device is continuing the function of the extended reality application (e.g., the swing-monitoring). In some embodiments, wearable device 712c may discontinue providing second haptic feedback signal (e.g., vibration haptic feedback signal 716b of FIG. 7B) after the cause for notification has ended and/or the information being communicated is no longer relevant (e.g., the racket 704c no longer being oriented incorrectly).

FIG. 7D shows user 702d holding a racket 704d, wearing extended reality headset 728d and wearable device 712d, and successfully contacting ball 718d in accordance with some embodiments. In some embodiments, wearable device 712d may continue to provide the first haptic feedback signal (e.g., pressure haptic feedback signal 716c) to user 702d to indicate that the computing device is continuing the function of the extended reality application (e.g., the swing-monitoring). In some embodiments, wearable device 712d may not continue to provide the first haptic feedback signal (e.g., pressure haptic feedback signal 716c) to user 702c to indicate that the computing device is continuing the function of the extended reality application (e.g., the swing-monitoring). In some embodiments, wearable device 712d may discontinue providing a haptic feedback signal after user 702d successfully contacts ball 718d.

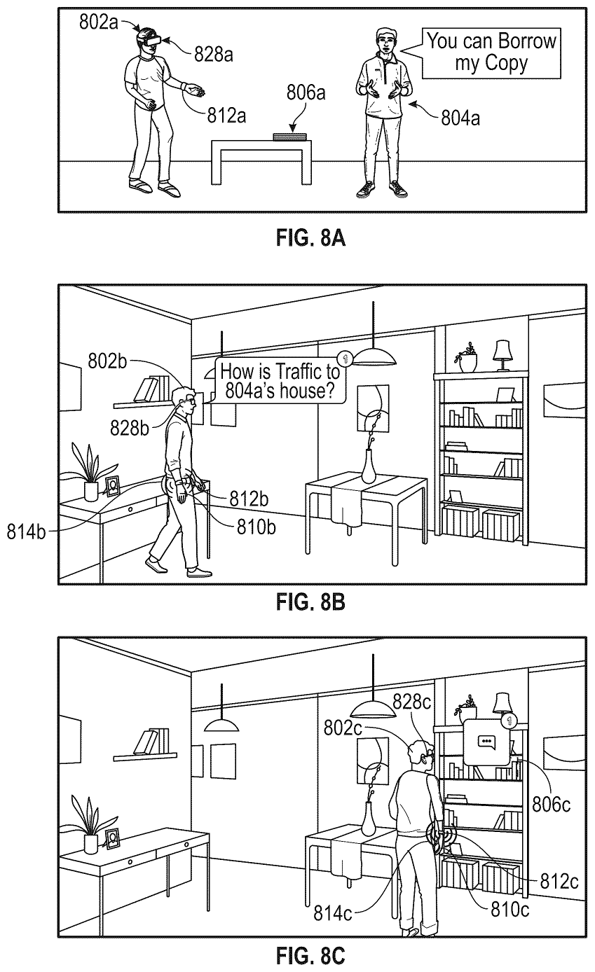

FIGS. 8A-C illustrate an example extended reality event wherein a wearable device provides a haptic feedback signal to a user based on an environmental response of an extended reality event (e.g., recognizing that a user has to perform a time sensitive task). The haptic feedback signal may be based on criteria of the environmental response of the extended reality event such as the extended reality event type and an urgency level of the extended reality event. For example, the wearable device may provide haptic feedback signals of differing intensities or characteristics based on how urgent, important, or time-sensitive the information is to the user. Additionally, the environmental response may be an event that occurs in the environment that requires a user's attention. For example, a wearable device may provide haptic feedback signals to provide a user with information when performing real-world activities such as cooking, or cleaning. The information may, for example, provide the user with a reminder to perform an operation (e.g., the wearable device may vibrate to indicate that the user should take something out of the oven).

FIG. 8A illustrates a first sub-event of the extended reality event. In FIG. 8A, user 802a, wearing extended reality headset 828a and wearable device 812a, is interacting with a person 804a in accordance with some embodiments. In the illustrated embodiment, the person 804a loans user 802a a book 806a. A computing device acknowledges that person 804a has loaned user 802a the book 806a, triggering the extended reality event. In some embodiments, the computing device may receive information from extended reality headset 828a to determine that that an environmental response or user action occurred (e.g., that the user 802a received book 806a or that user 802a performed a user action). In some embodiments, wearable device 812a may provide a haptic feedback signal to user 802a to indicate that it acknowledged the environmental response or user action. In other embodiments, wearable device 812a may not provide a haptic feedback signal to user 802a to indicate that it acknowledged the environmental response or user action.

FIG. 8B illustrates a second sub-event of the extended reality event at a time removed from FIG. 8A in accordance with some embodiments. In FIG. 8B, user 802b, wearing extended reality headset 828b and wearable device 812b, walks towards their bookshelf where they had previously shelved book 806a. The computing device may determine, based on environmental responses or user actions (e.g., determining that user 802b is intending to meet person 804a, because the user asked, for example, “[h]ow [] the traffic [was] to 804a's house”) that it should notify user 802b to bring the book 806a with user 802b. In some embodiments, the computing device may determine that an environmental response is occurring or will occur without any actions taken by user 802b. For example, the computing device may identify from one or more extended reality applications or computer applications (e.g., a calendar application) that the environmental response has occurred (e.g. user 802b is meeting person 804a). In some embodiments, the computing device may predict that environmental response will occur (e.g., user 802b intends to meet friend 804a). In some embodiments, wearable device 812b may provide a haptic feedback response (e.g., vibration haptic feedback response 812b) to user 802b.

FIG. 8C illustrates a third sub-event of the extended reality event in accordance with some embodiments. In FIG. 8C, user 802c, wearing extended reality headset 828c and wearable device 812c, walks up to bookshelf containing book 806c (same book as 806a). In the illustrated embodiment, the wearable device 812c provides a haptic feedback signal (e.g., vibration haptic feedback signal 814c) to user 802c to indicate that user 802c should bring book 806c. In some embodiments, extended reality headset 828c may provide additional information indicating what the notification relates to. In some embodiments, extended reality headset 828c may, in addition to vibration haptic feedback signal 814c, provide a visual or auditory notification to user 802c.

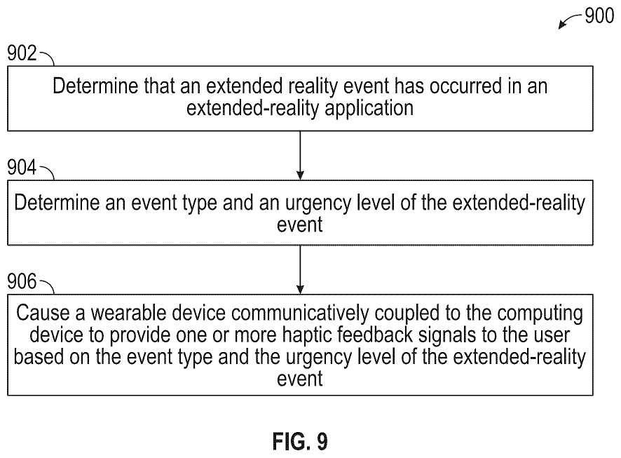

(A1) FIG. 9 illustrates a flow diagram of a method of providing information to a user regarding an extended reality event, in accordance with some embodiments. Operations (e.g., steps) of the method 900 can be performed by one or more processors (e.g., central processing unit and/or MCU) of a system, computing device, or wearable device. At least some of the operations shown in FIG. 9 correspond to instructions stored in a computer memory or computer-readable storage medium (e.g., storage, RAM, and/or memory) of the computing system. Operations of the method 900 can be performed by a single device alone or in conjunction with one or more processors and/or hardware components of another communicatively coupled device (e.g., computing device, wearable device) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

Method 900 includes determining (902) that an extended reality event has occurred in an extended reality application. The method 900 includes determining (904) an event type and an urgency level of the extended reality event. The method 900 includes causing (906) a wearable device communicatively coupled to the computing device to provide one or more haptic feedback signals to the user based on the event type and the urgency level of the extended reality event. In accordance with some embodiments, haptic feedback signal actuators may be arranged in a wearable device as provided in FIGS. 1A and B.

(A2) In accordance with some embodiments of A1, the one or more haptic feedback signals includes a vibration provided to the user.

(A3) In accordance with some embodiments of any of A1-A2, the one or more haptic feedback signals includes a pressure provided to the user.

(A4) In accordance with some embodiments of any of A1-A3, the extended reality event comprises one or more sub-events, each sub-event corresponding to user action in the extended reality event, an environmental response in the extended reality event, or a state change of the computing device. In accordance with some embodiments, the wearable device provides at least one haptic feedback signal based on the sub-event.

(A5) In accordance with some embodiments of any of A1-A4, the extended reality event comprises a first sub-event and a second sub-event. In accordance with some embodiments, the first sub-event is that the computing device started a function, and the computing device causes the wearable device to provide a first haptic feedback signal to the user indicating the first sub-event occurred. In accordance with some embodiments, the second sub-event is that the computing device completed the function started in the first sub-event, and the computing device causes the wearable device to provide a second haptic feedback signal to the user indicating the second sub-event occurred.

(A6) In accordance with some embodiments of any of A1-A5, the extended reality event comprises first sub-event, a second sub-event, and a third sub-event. In accordance with some embodiments, the first sub-event is that the computing device started a function, and the computing device causes the wearable device to provide a first haptic feedback signal to the user indicating the first sub-event occurred. In accordance with some embodiments, the second sub-event is one or more user actions, and the computing device causes the wearable device to provide one or more second haptic feedback signal to the user based on the one or more user actions. In accordance with some embodiments, the third sub-event is that the computing device completed the function started in the first sub-event, and the computing device causes the wearable device to provide a third haptic feedback signal to the user indicating the third sub-event occurred.

(A7) In accordance with some embodiments of any of A1-A6, each of the haptic feedback signals based on the first sub-event, second sub-event, and third sub-event is one of momentary, pulsing, or sustained haptic feedback signal.

(A8) In accordance with some embodiments of any of A1-A7, the one or more second haptic feedback signal corresponds to a suggested user action.

(A9) In accordance with some embodiments of any of A1-A8, the suggested user action is based on a determination, by the computing device, regarding one or more of a position of the user, position of an object the user is interacting with, position of an extended reality object the user is interacting with, force exerted by the user, and limb orientation and dynamics of the user.

(A10) In accordance with some embodiments of any of A1-A9, the method includes causing the wearable device to provide a second haptic feedback signal to the user, indicating that the computing device acknowledged a user action.

(A11) In accordance with some embodiments of any of A1-A10, the second sub-event involves the user interacting with a physical object.

(A12) In accordance with some embodiments of any of A1-A11, the second sub-event involves the user interacting with an extended reality object.

(A13) In accordance with some embodiments of any of A1-A12, the method includes causing the wearable device to provide two of the one or more haptic feedback signals to the user simultaneously.

(A14) In accordance with some embodiments of any of A1-A13, a first of the two of the one or more haptic feedback signals provided to the user simultaneously includes a pressure and a second of the two of the one or more haptic feedback signals provided to the user simultaneously includes a vibration.

(A15) In accordance with some embodiments of any of A1-A14, the wearable device is a wrist-wearable device.

(B1) In accordance with some embodiments, a system that includes a wrist wearable device (or a plurality of wrist-wearable devices) and a pair of augmented-reality glasses, and the system is configured to perform operations corresponding to any of A1-A15.

(C1) In accordance with some embodiments, a non-transitory computer readable storage medium including instructions that, when executed by a computing device in communication with a pair of augmented-reality glasses, cause the computer device to perform operations corresponding to any of A1-A15.

(D1) In accordance with some embodiments, a method of operating a pair of augmented-reality glasses, including operations that correspond to any of A1-A15.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended Reality Systems

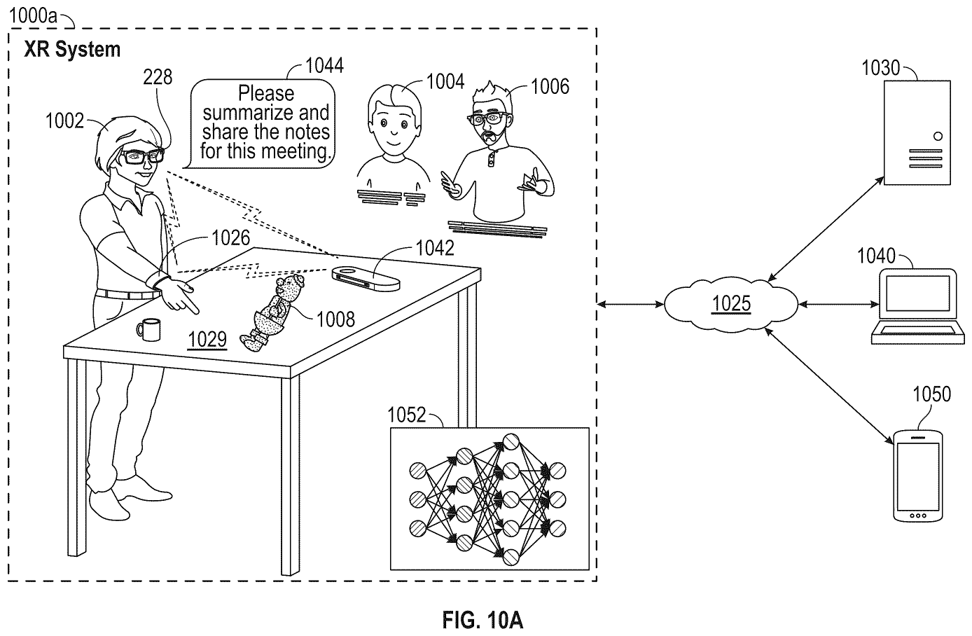

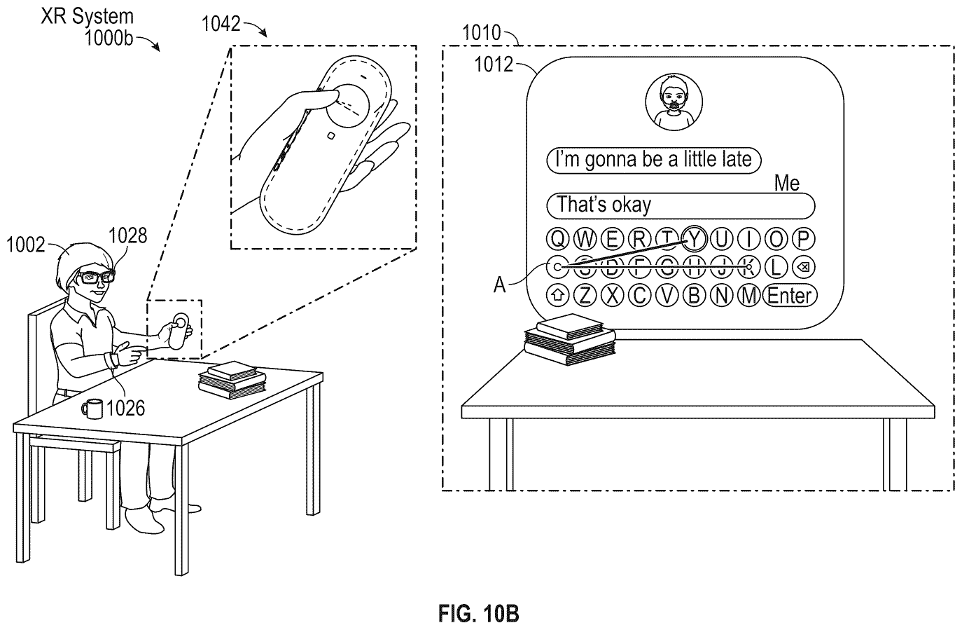

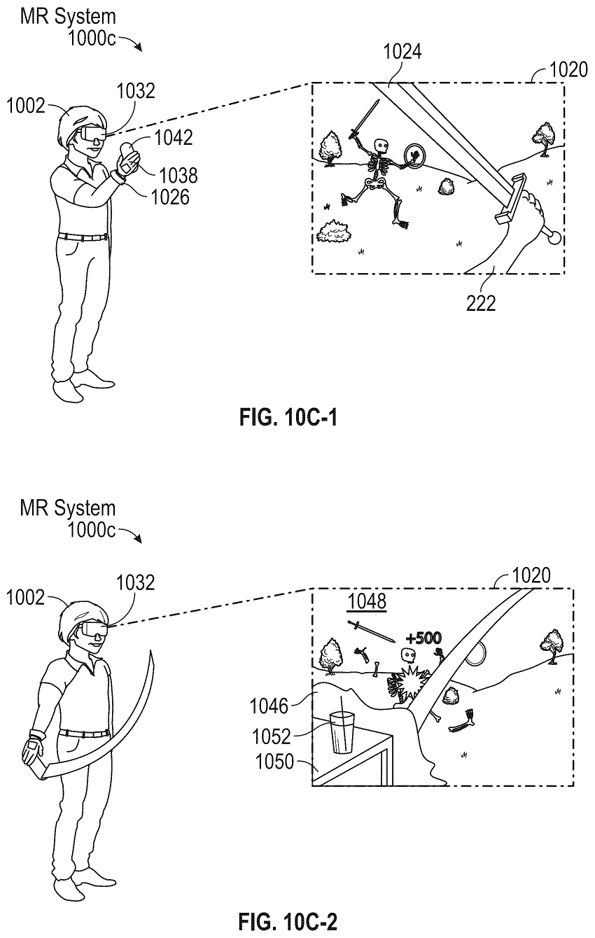

FIG. 10A 10B, 10C-1, and 10C-2, illustrate example XR systems that include AR and MR systems, in accordance with some embodiments. FIG. 10A shows a first XR system 1000a and first example user interactions using a wrist-wearable device 1026, a head-wearable device (e.g., AR device 1028), and/or a HIPD 1042. FIG. 10B shows a second XR system 1000b and second example user interactions using a wrist-wearable device 1026, AR device 1028, and/or an HIPD 1042. FIGS. 10C-1 and 10C-2 show a third MR system 1000c and third example user interactions using a wrist-wearable device 1026, a head-wearable device (e.g., an MR device such as a VR device), and/or an HIPD 1042. As the skilled artisan will appreciate upon reading the descriptions provided herein, the above-example AR and MR systems (described in detail below) can perform various functions and/or operations.

The wrist-wearable device 1026, the head-wearable devices, and/or the HIPD 1042 can communicatively couple via a network 1025 (e.g., cellular, near field, Wi-Fi, personal area network, wireless LAN). Additionally, the wrist-wearable device 1026, the head-wearable device, and/or the HIPD 1042 can also communicatively couple with one or more servers 1030, computers 1040 (e.g., laptops, computers), mobile devices 1050 (e.g., smartphones, tablets), and/or other electronic devices via the network 1025 (e.g., cellular, near field, Wi-Fi, personal area network, wireless LAN). Similarly, a smart textile-based garment, when used, can also communicatively couple with the wrist-wearable device 1026, the head-wearable device(s), the HIPD 1042, the one or more servers 1030, the computers 1040, the mobile devices 1050, and/or other electronic devices via the network 1025 to provide inputs.

Turning to FIG. 10A, a user 1002 is shown wearing the wrist-wearable device 1026 and the AR device 1028 and having the HIPD 1042 on their desk. The wrist-wearable device 1026, the AR device 1028, and the HIPD 1042 facilitate user interaction with an AR environment. In particular, as shown by the first AR system 1000a, the wrist-wearable device 1026, the AR device 1028, and/or the HIPD 1042 cause presentation of one or more avatars 1004, digital representations of contacts 1006, and virtual objects 1008. As discussed below, the user 1002 can interact with the one or more avatars 1004, digital representations of the contacts 1006, and virtual objects 1008 via the wrist-wearable device 1026, the AR device 1028, and/or the HIPD 1042. In addition, the user 1002 is also able to directly view physical objects in the environment, such as a physical table 1029, through transparent lens(es) and waveguide(s) of the AR device 1028. Alternatively, an MR device could be used in place of the AR device 1028 and a similar user experience can take place, but the user would not be directly viewing physical objects in the environment, such as table 1029, and would instead be presented with a virtual reconstruction of the table 1029 produced from one or more sensors of the MR device (e.g., an outward facing camera capable of recording the surrounding environment).

The user 1002 can use any of the wrist-wearable device 1026, the AR device 1028 (e.g., through physical inputs at the AR device and/or built-in motion tracking of a user's extremities), a smart-textile garment, externally mounted extremity tracking device, the HIPD 1042 to provide user inputs, etc. For example, the user 1002 can perform one or more hand gestures that are detected by the wrist-wearable device 1026 (e.g., using one or more EMG sensors and/or IMUs built into the wrist-wearable device) and/or AR device 1028 (e.g., using one or more image sensors or cameras) to provide a user input. Alternatively, or additionally, the user 1002 can provide a user input via one or more touch surfaces of the wrist-wearable device 1026, the AR device 1028, and/or the HIPD 1042, and/or voice commands captured by a microphone of the wrist-wearable device 1026, the AR device 1028, and/or the HIPD 1042. The wrist-wearable device 1026, the AR device 1028, and/or the HIPD 1042 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1028 (e.g., via an input at a temple arm of the AR device 1028). In some embodiments, the user 1002 can provide a user input via one or more facial gestures and/or facial expressions. For example, cameras of the wrist-wearable device 1026, the AR device 1028, and/or the HIPD 1042 can track the user 1002's eyes for navigating a user interface.

The wrist-wearable device 1026, the AR device 1028, and/or the HIPD 1042 can operate alone or in conjunction to allow the user 1002 to interact with the AR environment. In some embodiments, the HIPD 1042 is configured to operate as a central hub or control center for the wrist-wearable device 1026, the AR device 1028, and/or another communicatively coupled device. For example, the user 1002 can provide an input to interact with the AR environment at any of the wrist-wearable device 1026, the AR device 1028, and/or the HIPD 1042, and the HIPD 1042 can identify one or more back-end and front-end tasks to cause the performance of the requested interaction and distribute instructions to cause the performance of the one or more back-end and front-end tasks at the wrist-wearable device 1026, the AR device 1028, and/or the HIPD 1042. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1042 can perform the back-end tasks and provide the wrist-wearable device 1026 and/or the AR device 1028 operational data corresponding to the performed back-end tasks such that the wrist-wearable device 1026 and/or the AR device 1028 can perform the front-end tasks. In this way, the HIPD 1042, which has more computational resources and greater thermal headroom than the wrist-wearable device 1026 and/or the AR device 1028, performs computationally intensive tasks and reduces the computer resource utilization and/or power usage of the wrist-wearable device 1026 and/or the AR device 1028.

In the example shown by the first AR system 1000a, the HIPD 1042 identifies one or more back-end tasks and front-end tasks associated with a user request to initiate an AR video call with one or more other users (represented by the avatar 1004 and the digital representation of the contact 1006) and distributes instructions to cause the performance of the one or more back-end tasks and front-end tasks. In particular, the HIPD 1042 performs back-end tasks for processing and/or rendering image data (and other data) associated with the AR video call and provides operational data associated with the performed back-end tasks to the AR device 1028 such that the AR device 1028 performs front-end tasks for presenting the AR video call (e.g., presenting the avatar 1004 and the digital representation of the contact 1006).

In some embodiments, the HIPD 1042 can operate as a focal or anchor point for causing the presentation of information. This allows the user 1002 to be generally aware of where information is presented. For example, as shown in the first AR system 1000a, the avatar 1004 and the digital representation of the contact 1006 are presented above the HIPD 1042. In particular, the HIPD 1042 and the AR device 1028 operate in conjunction to determine a location for presenting the avatar 1004 and the digital representation of the contact 1006. In some embodiments, information can be presented within a predetermined distance from the HIPD 1042 (e.g., within five meters). For example, as shown in the first AR system 1000a, virtual object 1008 is presented on the desk some distance from the HIPD 1042. Similar to the above example, the HIPD 1042 and the AR device 1028 can operate in conjunction to determine a location for presenting the virtual object 1008. Alternatively, in some embodiments, presentation of information is not bound by the HIPD 1042. More specifically, the avatar 1004, the digital representation of the contact 1006, and the virtual object 1008 do not have to be presented within a predetermined distance of the HIPD 1042. While an AR device 1028 is described working with an HIPD, an MR headset can be interacted with in the same way as the AR device 1028.

User inputs provided at the wrist-wearable device 1026, the AR device 1028, and/or the HIPD 1042 are coordinated such that the user can use any device to initiate, continue, and/or complete an operation. For example, the user 1002 can provide a user input to the AR device 1028 to cause the AR device 1028 to present the virtual object 1008 and, while the virtual object 1008 is presented by the AR device 1028, the user 1002 can provide one or more hand gestures via the wrist-wearable device 1026 to interact and/or manipulate the virtual object 1008. While an AR device 1028 is described working with a wrist-wearable device 1026, an MR headset can be interacted with in the same way as the AR device 1028.

### Integration of Artificial Intelligence With XR Systems

FIG. 10A illustrates an interaction in which an artificially intelligent virtual assistant can assist in requests made by a user 1002. The AI virtual assistant can be used to complete open-ended requests made through natural language inputs by a user 1002. For example, in FIG. 10A the user 1002 makes an audible request 1044 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 10A also illustrates an example neural network 1052 used in Artificial Intelligence applications. Uses of Artificial Intelligence (AI) are varied and encompass many different aspects of the devices and systems described herein. AI capabilities cover a diverse range of applications and deepen interactions between the user 1002 and user devices (e.g., the AR device 1028, an MR device 1032, the HIPD 1042, the wrist-wearable device 1026). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1002 can interact with an AI model through natural language inputs captured by a voice sensor, text inputs, or any other input modality that accepts natural language and/or a corresponding voice sensor module. In another instance, input is provided by tracking the eye gaze of a user 1002 via a gaze tracker module. Additionally, the AI model can also receive inputs beyond those supplied by a user 1002. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 1028) or from multiple devices that are in communication with each other (e.g., a system that includes at least two of an AR device 1028, an MR device 1032, the HIPD 1042, the wrist-wearable device 1026, etc.). The AI model can also access additional information (e.g., one or more servers 1030, the computers 1040, the mobile devices 1050, and/or other electronic devices) via a network 1025.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1028, an MR device 1032, the HIPD 1042, the wrist-wearable device 1026) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1028, an MR device 1032, the HIPD 1042, the wrist-wearable device 1026), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1042), haptic feedback can provide information to the user 1002. An AI model can also use the inputs described above to determine the appropriate modality and device(s) to present content to the user (e.g., a user walking on a busy road can be presented with an audio output instead of a visual output to avoid distracting the user 1002).

### Example Augmented Reality Interaction

FIG. 10B shows the user 1002 wearing the wrist-wearable device 1026 and the AR device 1028 and holding the HIPD 1042. In the second AR system 1000b, the wrist-wearable device 1026, the AR device 1028, and/or the HIPD 1042 are used to receive and/or provide one or more messages to a contact of the user 1002. In particular, the wrist-wearable device 1026, the AR device 1028, and/or the HIPD 1042 detect and coordinate one or more user inputs to initiate a messaging application and prepare a response to a received message via the messaging application.

In some embodiments, the user 1002 initiates, via a user input, an application on the wrist-wearable device 1026, the AR device 1028, and/or the HIPD 1042 that causes the application to initiate on at least one device. For example, in the second AR system 1000b the user 1002 performs a hand gesture associated with a command for initiating a messaging application (represented by messaging user interface 1012); the wrist-wearable device 1026 detects the hand gesture; and, based on a determination that the user 1002 is wearing the AR device 1028, causes the AR device 1028 to present a messaging user interface 1012 of the messaging application. The AR device 1028 can present the messaging user interface 1012 to the user 1002 via its display (e.g., as shown by user 1002's field of view 1010). In some embodiments, the application is initiated and can be run on the device (e.g., the wrist-wearable device 1026, the AR device 1028, and/or the HIPD 1042) that detects the user input to initiate the application, and the device provides another device operational data to cause the presentation of the messaging application. For example, the wrist-wearable device 1026 can detect the user input to initiate a messaging application, initiate and run the messaging application, and provide operational data to the AR device 1028 and/or the HIPD 1042 to cause presentation of the messaging application. Alternatively, the application can be initiated and run at a device other than the device that detected the user input. For example, the wrist-wearable device 1026 can detect the hand gesture associated with initiating the messaging application and cause the HIPD 1042 to run the messaging application and coordinate the presentation of the messaging application.

Further, the user 1002 can provide a user input provided at the wrist-wearable device 1026, the AR device 1028, and/or the HIPD 1042 to continue and/or complete an operation initiated at another device. For example, after initiating the messaging application via the wrist-wearable device 1026 and while the AR device 1028 presents the messaging user interface 1012, the user 1002 can provide an input at the HIPD 1042 to prepare a response (e.g., shown by the swipe gesture performed on the HIPD 1042). The user 1002's gestures performed on the HIPD 1042 can be provided and/or displayed on another device. For example, the user 1002's swipe gestures performed on the HIPD 1042 are displayed on a virtual keyboard of the messaging user interface 1012 displayed by the AR device 1028.

In some embodiments, the wrist-wearable device 1026, the AR device 1028, the HIPD 1042, and/or other communicatively coupled devices can present one or more notifications to the user 1002. The notification can be an indication of a new message, an incoming call, an application update, a status update, etc. The user 1002 can select the notification via the wrist-wearable device 1026, the AR device 1028, or the HIPD 1042 and cause presentation of an application or operation associated with the notification on at least one device. For example, the user 1002 can receive a notification that a message was received at the wrist-wearable device 1026, the AR device 1028, the HIPD 1042, and/or other communicatively coupled device and provide a user input at the wrist-wearable device 1026, the AR device 1028, and/or the HIPD 1042 to review the notification, and the device detecting the user input can cause an application associated with the notification to be initiated and/or presented at the wrist-wearable device 1026, the AR device 1028, and/or the HIPD 1042.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1028 can present to the user 1002 game application data and the HIPD 1042 can use a controller to provide inputs to the game. Similarly, the user 1002 can use the wrist-wearable device 1026 to initiate a camera of the AR device 1028, and the user can use the wrist-wearable device 1026, the AR device 1028, and/or the HIPD 1042 to manipulate the image capture (e.g., zoom in or out, apply filters) and capture image data.

While an AR device 1028 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 10C-1 and 10C-2, the user 1002 is shown wearing the wrist-wearable device 1026 and an MR device 1032 (e.g., a device capable of providing either an entirely VR experience or an MR experience that displays object(s) from a physical environment at a display of the device) and holding the HIPD 1042. In the third AR system 1000c, the wrist-wearable device 1026, the MR device 1032, and/or the HIPD 1042 are used to interact within an MR environment, such as a VR game or other MR/VR application. While the MR device 1032 presents a representation of a VR game (e.g., first MR game environment 1020) to the user 1002, the wrist-wearable device 1026, the MR device 1032, and/or the HIPD 1042 detect and coordinate one or more user inputs to allow the user 1002 to interact with the VR game.

In some embodiments, the user 1002 can provide a user input via the wrist-wearable device 1026, the MR device 1032, and/or the HIPD 1042 that causes an action in a corresponding MR environment. For example, the user 1002 in the third MR system 1000c (shown in FIG. 10C-1) raises the HIPD 1042 to prepare for a swing in the first MR game environment 1020. The MR device 1032, responsive to the user 1002 raising the HIPD 1042, causes the MR representation of the user 1022 to perform a similar action (e.g., raise a virtual object, such as a virtual sword 1024). In some embodiments, each device uses respective sensor data and/or image data to detect the user input and provide an accurate representation of the user 1002's motion. For example, image sensors (e.g., SLAM cameras or other cameras) of the HIPD 1042 can be used to detect a position of the HIPD 1042 relative to the user 1002's body such that the virtual object can be positioned appropriately within the first MR game environment 1020; sensor data from the wrist-wearable device 1026 can be used to detect a velocity at which the user 1002 raises the HIPD 1042 such that the MR representation of the user 1022 and the virtual sword 1024 are synchronized with the user 1002's movements; and image sensors of the MR device 1032 can be used to represent the user 1002's body, boundary conditions, or real-world objects within the first MR game environment 1020.

In FIG. 10C-2, the user 1002 performs a downward swing while holding the HIPD 1042. The user 1002's downward swing is detected by the wrist-wearable device 1026, the MR device 1032, and/or the HIPD 1042 and a corresponding action is performed in the first MR game environment 1020. In some embodiments, the data captured by each device is used to improve the user's experience within the MR environment. For example, sensor data of the wrist-wearable device 1026 can be used to determine a speed and/or force at which the downward swing is performed and image sensors of the HIPD 1042 and/or the MR device 1032 can be used to determine a location of the swing and how it should be represented in the first MR game environment 1020, which, in turn, can be used as inputs for the MR environment (e.g., game mechanics, which can use detected speed, force, locations, and/or aspects of the user 1002's actions to classify a user's inputs (e.g., user performs a light strike, hard strike, critical strike, glancing strike, miss) or calculate an output (e.g., amount of damage)).

FIG. 10C-2 further illustrates that a portion of the physical environment is reconstructed and displayed at a display of the MR device 1032 while the MR game environment 1020 is being displayed. In this instance, a reconstruction of the physical environment 1046 is displayed in place of a portion of the MR game environment 1020 when object(s) in the physical environment are potentially in the path of the user (e.g., a collision with the user and an object in the physical environment are likely). Thus, this example MR game environment 1020 includes (i) an immersive VR portion 1048 (e.g., an environment that does not have a corollary counterpart in a nearby physical environment) and (ii) a reconstruction of the physical environment 1046 (e.g., table 1050 and cup 1052). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1026, the MR device 1032, and/or the HIPD 1042 are described as detecting user inputs, in some embodiments, user inputs are detected at a single device (with the single device being responsible for distributing signals to the other devices for performing the user input). For example, the HIPD 1042 can operate an application for generating the first MR game environment 1020 and provide the MR device 1032 with corresponding data for causing the presentation of the first MR game environment 1020, as well as detect the user 1002's movements (while holding the HIPD 1042) to cause the performance of corresponding actions within the first MR game environment 1020. Additionally or alternatively, in some embodiments, operational data (e.g., sensor data, image data, application data, device data, and/or other data) of one or more devices is provided to a single device (e.g., the HIPD 1042) to process the operational data and cause respective devices to perform an action associated with processed operational data.

In some embodiments, the user 1002 can wear a wrist-wearable device 1026, wear an MR device 1032, wear smart textile-based garments 1038 (e.g., wearable haptic gloves), and/or hold an HIPD 1042 device. In this embodiment, the wrist-wearable device 1026, the MR device 1032, and/or the smart textile-based garments 1038 are used to interact within an MR environment (e.g., any AR or MR system described above in reference to FIGS. 10A-10B). While the MR device 1032 presents a representation of an MR game (e.g., second MR game environment 1020) to the user 1002, the wrist-wearable device 1026, the MR device 1032, and/or the smart textile-based garments 1038 detect and coordinate one or more user inputs to allow the user 1002 to interact with the MR environment.

In some embodiments, the user 1002 can provide a user input via the wrist-wearable device 1026, an HIPD 1042, the MR device 1032, and/or the smart textile-based garments 1038 that causes an action in a corresponding MR environment. In some embodiments, each device uses respective sensor data and/or image data to detect the user input and provide an accurate representation of the user 1002's motion. While four different input devices are shown (e.g., a wrist-wearable device 1026, an MR device 1032, an HIPD 1042, and a smart textile-based garment 1038) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1038) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1038 can be used in conjunction with an MR device and/or an HIPD 1042.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 10A-10C-2 provided above are intended to augment the description provided in reference to FIGS. 1-9. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of providing information to a user regarding an extended reality event, the method comprising:
determining, by a computing device, that the extended reality event has occurred in an extended reality application;
determining, by the computing device, an event type and an urgency level of the extended reality event; and
causing a wearable device communicatively coupled to the computing device to provide one or more haptic feedback signals to the user based on the event type and the urgency level of the extended reality event.

2. The method of claim 1, wherein the one or more haptic feedback signals includes a pressure provided to the user.

3. The method of claim 1, wherein the one or more haptic feedback signals includes a vibration provided to the user.

4. The method of claim 1, wherein:
the extended reality event comprises one or more sub-events, each sub-event corresponding to user action in the extended reality event, an environmental response in the extended reality event, or a state change of the computing device; and
the wearable device provides at least one haptic feedback signal based on the sub-event.

5. The method of claim 4, wherein the extended reality event comprises:
a first sub-event, wherein the first sub-event is that the computing device started a function, and the computing device causes the wearable device to provide a first haptic feedback signal to the user indicating the first sub-event occurred; and
a second sub-event, wherein the second sub-event is that the computing device completed the function started in the first sub-event, and the computing device causes the wearable device to provide a second haptic feedback signal to the user indicating the second sub-event occurred.

6. The method of claim 4, wherein the extended reality event comprises:
a first sub-event, wherein the first sub-event is that the computing device started a function, and the computing device causes the wearable device to provide a first haptic feedback signal to the user indicating the first sub-event occurred;
a second sub-event, wherein the second sub-event is one or more user actions, and the computing device causes the wearable device to provide one or more second haptic feedback signal to the user based on the one or more user actions; and
a third sub-event, wherein the third sub-event is that the computing device completed the function started in the first sub-event, and the computing device causes the wearable device to provide a third haptic feedback signal to the user indicating the third sub-event occurred.

7. The method of claim 6, wherein each of the haptic feedback signals based on the first sub-event, second sub-event, and third sub-event is one of momentary, pulsing, or sustained haptic feedback signal.

8. The method of claim 7, wherein the one or more second haptic feedback signal corresponds to a suggested user action.

9. The method of claim 8, wherein the suggested user action is based on a determination, by the computing device, regarding one or more of a position of the user, position of an object the user is interacting with, position of an extended reality object the user is interacting with, force exerted by the user, and limb orientation and dynamics of the user.

10. The method of claim 6, further comprising causing the wearable device to provide a second haptic feedback signal to the user, indicating that the computing device acknowledged a user action.

11. The method of claim 6, wherein the second sub-event involves the user interacting with a physical object.

12. The method of claim 6, wherein the second sub-event involves the user interacting with a virtual reality object.

13. The method of claim 1, further comprising causing the wearable device to provide two of the one or more haptic feedback signals to the user simultaneously.

14. The method of claim 13, wherein a first of the two of the one or more haptic feedback signals provided to the user simultaneously includes a pressure and a second of the two of the one or more haptic feedback signals provided to the user simultaneously includes a vibration.

15. The method of claim 1, wherein the wearable device is a wrist-wearable device.

16. A wearable device communicatively coupled to a computing device, comprising:
a vibration actuator; and
a pressure actuator, wherein the computing device is configured to:
determine that an extended reality event has occurred in an extended reality application;
determine an event type and an urgency level of the extended reality event; and
cause the wearable device to provide one or more haptic feedback signals to a user based on the event type and the urgency level of the extended reality event.

17. The wearable device of claim 16, wherein the wearable device is a wrist-wearable device.

18. A non-transitory, computer-readable storage medium including executable instructions that, when executed by one or more processors, cause the one or more processors to:
determine that an extended reality event has occurred in an extended reality application;
determine an event type and an urgency level of the extended reality event; and
cause, based on the event type and the urgency level of the event, a wearable device to provide one or more haptic feedback signals to a user.

19. The computer-readable storage medium of claim 18, wherein:
the extended reality event comprises one or more sub-events, each sub-event corresponding to user action in the extended reality event, an environmental response in the extended reality event, or a state change of a computing device; and
the wearable device provides at least one haptic feedback signal based on the sub-event.

20. The computer-readable storage medium of claim 19, wherein the extended reality event comprises:
a first sub-event, wherein the first sub-event is that the computing device started a function, and the computing device causes the wearable device to provide a first haptic feedback signal to the user indicating the first sub-event occurred; and
a second sub-event, wherein the second sub-event is that the computing device completed the function started in the first sub-event, and the computing device causes the wearable device to provide a second haptic feedback signal to the user indicating the second sub-event occurred.
